(19) United States
(12) Patent Application Publication
(10) Pub. No.: US 2009/0053345 A1
(43) Pub. Date: Feb. 26, 2009

(54) Concrete slip forming device

(76) Inventors: Jose Luis Simoes Martins, Etobicoke (CA); Afonso Condeco, Etobicoke (CA)

Correspondence Address: Elias C. Borges, Suite 406, 555 Burnhamthorpe Road, Toronto, ON, M9C 2Y3, CA

(21) Appl. No.: 11/892,317

(22) Filed: Aug. 22, 2007

(51) Int. Cl. B28B 1/26

(52) U.S. Cl. 425/64

(57) ABSTRACT

The present invention is an improved slip forming device for forming a concrete curb having a desired profile. The device consists of a hopper portion and a removeable extruder portion, the extruder portion being adapted and configured to extrude the concrete curb having the desired profile. The hopper portion of the invention has a top, an open bottom, side walls and a back wall having an opening. The extruder portion of the invention has a front wall, a back wall, a closed top, and open bottom and side walls. The front wall of the extruder has a front opening and the back wall of the extruder has a rear opening, the top and side walls of the extruder forming a channel between the front and rear openings of the extruder. The rear opening of the extruder is substantially in the form of the desired profile. The front wall of the extruder is releasably mounted to the back wall of the hopper such that the front opening of the extruder is in communication with the opening of the hopper. The device includes a pair of mounting arms mounted to the hopper and extending away from the hopper, the extruder being mounted to the support arms. The extruder is releasably mounted to the hopper by means of a plurality of mounting flanges positioned on the back wall of the hopper and the front wall of the extruder, the mounting flanges being held together by mounting bolts.

### FIELD OF THE INVENTION

The invention relates generally to devices for molding sidewalk or roadway curbs from concrete.

### BACKGROUND OF THE INVENTION

Concrete slip forming devices for forming concrete curbs are well known. They generally consist of a large hopper/mixer device which stores and mixes a quantity of concrete and an extruder formed on the underside of the hopper for molding and extruding the curb in the correct profile. As can be imagined, given the size of many roadway and sidewalk cubs, these concrete slip forming devices tend to be quite large and are usually mounted behind a large tractor. Since the extruder is an integral part of the hopper, the overall design is robust and strong. While this is an efficient and reliable design, an integral hopper and extruder have the disadvantage of requiring the user to remove the hopper when a curb with a different profile is required. Given the large size of the hopper, it can be difficult to change the hopper and requires the efforts of several individuals working in concert. As a result, it can take a long time to change the equipment when a new curb profile is required. Furthermore, it will be appreciated that an inventory of hoppers will be required if the user is to have a choice of which curb profile to use. This adds to the cost of operating the slip forming device. An improved slip forming device is therefore required.

### SUMMARY OF THE INVENTION

In accordance with one aspect of the present invention, there is provided an improved slip forming device for forming a concrete curb having a desired profile. The device consists of a hopper portion and a removeable extruder portion, the extruder portion being adapted and configured to extrude the concrete curb having the desired profile. The hopper portion of the invention has a top, an open bottom, side walls and a back wall having an opening. The extruder portion of the invention has a front wall, a back wall, a closed top, and open bottom and side walls. The front wall of the extruder has a front opening and the back wall of the extruder has a rear opening, the top and side walls of the extruder forming a channel between the front and rear openings of the extruder. The rear opening of the extruder is substantially in the form of the desired profile. The front wall of the extruder is releasably mounted to the back wall of the hopper such that the front opening of the extruder is in communication with the opening of the hopper.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of the hopper portion of the present invention.

FIG. 2 is a top view of the present invention showing the extruder portion of the present invention being detached from the hopper portion of the invention.

FIG. 3 is a front view of the extruder portion of the present invention taken along line A-A of FIG. 2.

FIG. 4 is a side view of the present invention showing the extruder portion of the present invention being detached from the hopper portion of the invention.

FIG. 5 is a back view of the extruder portion of the invention.

In the drawings like characters of reference indicate corresponding parts in the different figures.

### DETAILED DESCRIPTION OF THE INVENTION

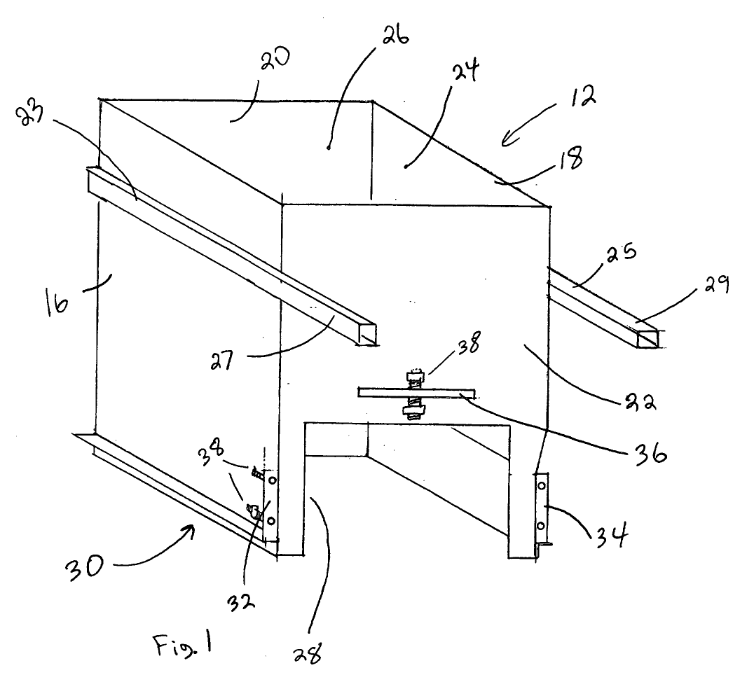

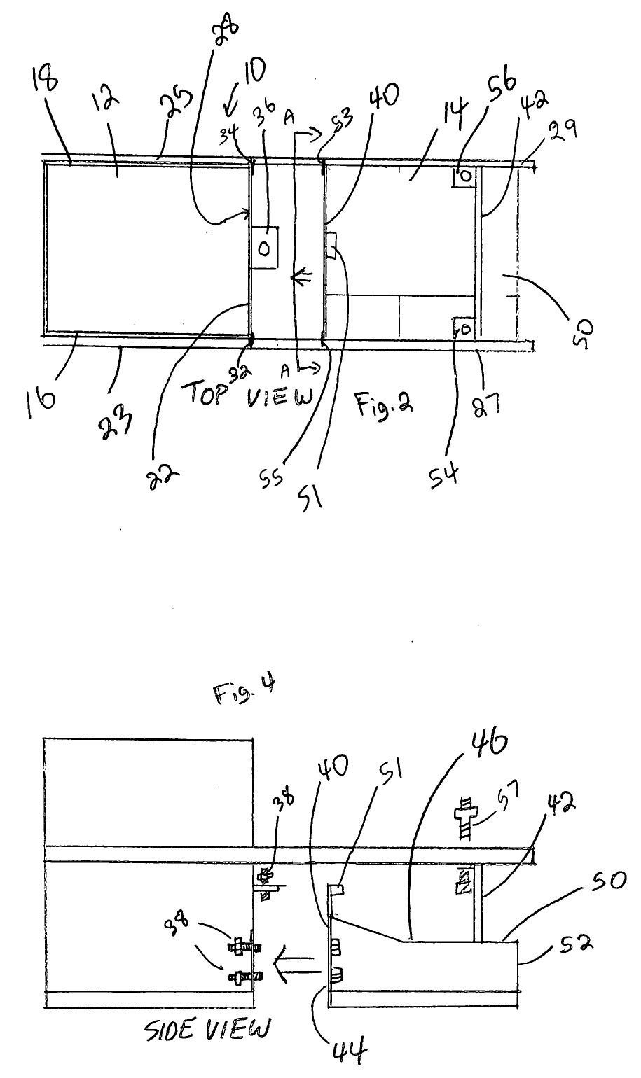

Referring firstly to FIG. 2, the present invention, shown generally as item 10, consists of a hopper portion 12 releasably mounted to an extruder portion 14. As best seen in FIG. 1, hopper 12 consists of a large hopper having side walls 16 and 18, front wall 20, back wall 22, open top 24, open bottom 30, interior 26 and opening 28 on back wall 22. Mounting arms 23 and 25 are mounted to side walls 16 and 18, respectively, and the side arms have ends 27 and 29, respectively, which project away from and beyond back wall 22 of the hopper. Mounting flanges 32, 34 and 36 are welded or otherwise formed onto back wall 22 of hopper 12 and each of said flanges are configured to receive mounting bolts 38.

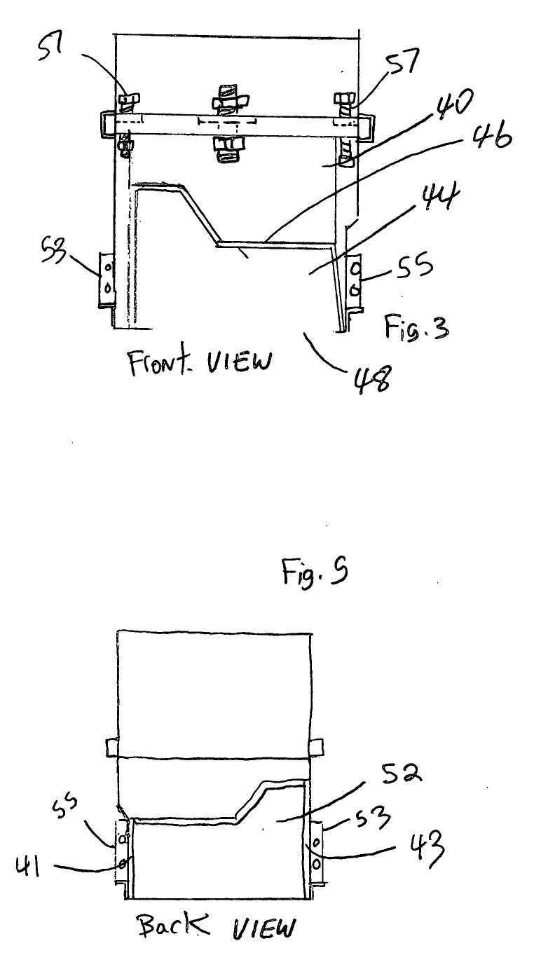

Referring now to FIGS. 2, 3, 4 and 5, extruder 14 has front wall 40, back wall 42, side walls 41 and 43, front opening 44, top 46, rear opening 52 and nozzle portion 50. Rear opening 52 and nozzle portion 50 have a cross sectional profile substantially in the form of the desired profile of the curb (not shown) which is to be slipformed using the device. Front wall 40 of extruder 14 and back wall 22 of hopper 12 are dimensioned to be substantially flat such that when the two are brought together they bear against each other closely with mounting element 51 on front wall 40 aligned with flange 36 of wall 22 and with flanges 32 and 34 aligned with mounting flanges 55 and 53 formed on front wall 40. With the flanges so aligned, back wall 22 of hopper 12 can be mounted tightly to front wall 40 of extruder 14 via mounting bolts 38. Openings 44 and 28 are positioned on walls 40 and 22 respectively such that when the two walls are mounted together, the two openings are in communication. It will be appreciated that wall 40 will be larger in dimension than opening 28 and that walls 40 and 22 are mounted sufficiently tightly together that material does not leak out of opening 28 between the walls but rather passes entirely from hopper 12 to extruder 14 through opening 44.

Extruder 14 has back wall 42 with aperture 52 formed thereon. Aperture 52 is substantially in the form of the desired cross sectional profile of the curb (or other item) to be slip formed (not shown). Side walls 41 and 43 and top 46 of the extruder form a molding channel to mold a curb (or other item) having the desired cross sectional profile. A portion of side walls 41 and 43 and top 46 extend beyond wall 42 to form a nozzle 50 which aids in forming a smooth well formed curb (or other item to be slipformed). Mounting brackets 54 and 56 are formed on wall 42 and provide a means to securely mount wall 42 to mounting arms 23 and 25, respectively, via removable mounting bolts 57. In this way, the back portion of extruder 14 adjacent nozzle 50 is supported by support arms 23 and 25.

The present invention has many advantages over the prior art. In particular, it is possible to form a variety of slipformed curbs having different cross sectional profiles simply by providing a variety of different extruder portions. Changing from one extruder to another is a simple task involving the removal of only a few bolts. Since the extruder is releasably mounted to the hopper, it is not necessary to remove the hopper in order to change extruders.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A slip forming device for forming a concrete curb having a desired profile, the device comprising:
a hopper having a top, an open bottom, side walls and a back wall having an opening;
an extruder having a front wall, a back wall, a closed top, and open bottom and side walls, the front wall of the extruder having a front opening and the back wall of the extruder having a rear opening, the top and side walls of the extruder forming a channel between the front and rear openings of the extruder, the rear opening being substantially in the form of the desired profile;
the front wall of the extruder being releasably mounted to the back wall of the hopper such that the front opening of the extruder is in communication with the opening of the hopper.

2. The slip forming device of claim 1 further including a pair of mounting arms mounted to the side walls of the hopper, the mounting arms extending away from the hopper, the extruder being mounted to the side arms such that the side arms support the extruder.

3. The slip forming device of claim 1 wherein the extruder further includes a nozzle portion which extends beyond the back wall of the extruder, the nozzle portion having a profile substantially in the shape of the desired profile.

4. The slip forming device of claim 1 wherein the back wall of the hopper and the front wall of the extruder each have a plurality of flanges, the flanges of the hopper being positioned to mate with the flanges of the extruder, the flanges of the hopper and extruder being mounted together by releasable mounting bolts.

5. The slip forming device of claim 2 wherein the back wall of the extruder is mounted to the mounting arms by releasable mounting bolts.

6. The slip forming device of claim 5 wherein the extruder further includes a nozzle portion which extends beyond the back wall of the extruder, the nozzle portion having a profile substantially in the shape of the desired profile.

7. The slip forming device of claim 6 wherein the back wall of the hopper and the front wall of the extruder each have a plurality of flanges, the flanges of the hopper being positioned to mate with the flanges of the extruder, the flanges of the hopper and extruder being mounted together by releasable mounting bolts.

8. The slip forming device of claim 6 wherein the nozzle comprises an extension of the channel formed by the side walls and top of the extruder.
